(19) United States
(12) Patent Application Publication
(10) Pub. No.: US 2010/0244453 A1
(43) Pub. Date: Sep. 30, 2010

(54) Vertical wind turbine

(76) Inventor: Mark Dornan, Brick, NJ (US)

Correspondence Address: CLIFFORD G. FRAYNE, 136 DRUM POINT RD, SUITE 7A, BRICK, NJ, 08723, US

(21) Appl. No.: 12/661,190

(22) Filed: Mar. 12, 2010

Related U.S. Application Data
(60) Provisional application No. 61/211,281, filed on Mar. 27, 2009.

(51) Int. Cl. F03D 9/00; F04D 29/44; F03B 17/04

(52) U.S. Cl. 290/55; 415/203; 415/916

(57) ABSTRACT

A vertical wind turbine rotatable on its vertical axis in order to capture the most direct vector of the wind, the vertical wind turbine having a horizontal inlet port in communication with a vertical air shaft within which mounted vertically, a shaft having a plurality of horizontally disposed wind turbine blades, the lower end magnetically floating to reduce friction, the lower portion of the vertical wind turbine shaft in intersecting communication with one or more horizontal shafts having a venturi design so as to draw a partial vacuum or low pressure, enhancing the downward flow of the air in the vertical wind turbine, the vertical wind turbine in communication with a generator for the production of electricity, the vertical wind turbine being rotatably but stationary mounted on a stationary object or fixedly mounted on a vehicle with the inlet port of the vertical wind turbine forwardly facing.

### RELATED APPLICATIONS

Applicant claims the benefit of provisional application Ser. No. 61/211,281, filed Mar. 27, 2009.

### BACKGROUND OF THE INVENTION

1. Field of the Invention

The present invention relates to the field of wind turbines as an alternative energy source, and more particularly, to an aesthetically pleasing wind turbine which functions in a vertical orientation, either stationary or on a vehicle.

2. Description of the Prior Art

Wind turbines or their equivalence, have been in use for hundreds of years. The earliest wind turbine, the windmill, converted wind energy into mechanical energy, normally to pump water. The fluctuation of petroleum prices and the popular ethic of “going green” has led to the development of wind turbines for the production of electricity. Vast areas of North America and other continents have prevailing wind patterns which makes these areas suitable for the establishment of wind farms with many pedestal mounted wind turbines converting the wind energy to electricity by the wind or air pressure inducing rotation of a turbine and its associated generator, thereby providing electricity to the nearest electrical grid.

Wind farms have been established in many areas of the world with many hundreds of pedestal mounted wind turbines providing electricity in the manner described. However, many view these wind farms as unsightly and not aesthetically pleasing. Still further, the very environmentalists who favor alternative energies, voice concerns at these massive wind farms with respect to the destruction or killing of migrating birds.

Wind turbines have also found recent favor and some degree of success with respect to being vehicularley mounted in order to recharge the batteries of an electric car or a hybrid car while the car or vehicle is moving, thus extending the distance which the electric car or hybrid car can travel without the need of a plug in recharge. The main limitation on electric and hybrid vehicles is that the vehicles will only allow travel of a specific distance on the batteries alone before a recharge is required. Normally this recharge is accomplished by an overnight plug in of the battery system. The adaptation of wind turbines onto the vehicle allows for the operation of the wind turbine while the vehicle is moving, allowing the wind turbine and associated generator to recharge the batteries at the same time the batteries are powering the car, thus extending the distance of travel.

Still further, miniature wind turbines of the pedestal mount type have found application in the boating industry, wherein a small miniature wind turbine is mounted on the top of a mast or other point on the superstructure, and which wind turbine and generator recharge the batteries of the boat while it is docked.

For efficiency sake, the wind turbines need to capture as much moving air as possible, and to convert it into electricity in the most efficient manner available. The large pedestal mounted turbines of wind farms are normally unidirectional and are most efficient when the air is blowing perpendicular to the blades of the turbine, incurring lesser efficiencies when the wind is at an angle to the blades. Still further, many aesthetical objections remain to the use of pedestal mounted turbines.

It is therefore the purpose of Applicant to develop a novel wind turbine which redirects the horizontal force of the wind into a vertical shaft or the like in which one or more wind turbines are mounted so as to magnetically float to reduce friction and coupled to a generator for the production of electricity, this vertical wind turbine being rotatable dependant upon the direction of the wind so as to always face the most direct vector of the wind, the turbine further being enhanced by horizontal air flow shafts proximate the lower portion of the vertical turbine so as to draw or create a venturi effect, partial vacuum or low pressure area which will further enhance the rotation of the turbine by means of the wind entering the vertical turbine.

### OBJECTS OF THE INVENTION

An object of the present invention is to provide for a novel vertical wind turbine which is aesthetically pleasing to the eye and which is rotatable so as to always face the most direct vector of the wind.

A still further object of the present invention is to provide for a novel vertical wind turbine in which the internal turbine blades are mounted so as to magnetically float to reduce friction and improve efficiency.

A still further object of the present invention is to provide for a novel vertical wind turbine which is aesthetically pleasing to the eye.

A still further object of the present invention is to provide for a novel vertical wind turbine which presents no danger to bird life.

A still further object of the present invention is to provide for a novel vertical wind turbine which can easily be mounted in or on a single structure, such as a house or office building for the generation of electricity for the particular structure.

A still further object of the present invention is to provide for a novel vertical wind turbine which can be mounted in or on an electric or hybrid vehicle so as to recharge the batteries of the vehicle while the vehicle is moving, thus extending the distance which the electric or hybrid vehicle can travel.

### SUMMARY OF THE INVENTION

A vertical wind turbine rotatable on its vertical axis in order to capture the most direct vector of the wind, the vertical wind turbine having a horizontal inlet port in communication with a vertical air shaft within which is mounted a vertical shaft having a plurality of horizontally disposed wind turbine blades, the lower end magnetically floating to reduce friction, the lower portion of the vertical wind turbine shaft in intersecting communication with one or more horizontal shafts having a venturi design so as to draw a partial vacuum or low pressure, enhancing the downward flow of the air in the vertical wind turbine, the vertical wind turbine in communication with a generator for the production of electricity, the vertical wind turbine being rotatably but stationary mounted on a stationary object or fixedly mounted on a vehicle with the inlet port of the vertical wind turbine forwardly facing.

### BRIEF DESCRIPTION OF THE DRAWINGS

FIG. 1 is a cross-sectional view of a vertical wind turbine of the present invention which is rotatable in reaction to the primary directional vector of the wind so as to capture the direct thrust of the wind;

FIG. 2 is a cross-sectional prospective view of the vertical wind turbine of the present invention illustrating an embodiment which could be utilized to mount in or on a stationary object such as a house, office building, or the like;

FIG. 3 is a perspective cross-sectional view of a vertical wind turbine of the present invention mounted in or on an electric or hybrid vehicle;

FIG. 4 is a perspective cross-sectional view of an embodiment of the vertical wind tunnel in which two vertical wind turbines are mounted in or on the vehicle; and

FIGS. 5 and 6 are cross-sectional alternating embodiments of the vertical air flow shaft.

### DETAILED DESCRIPTION OF THE INVENTION

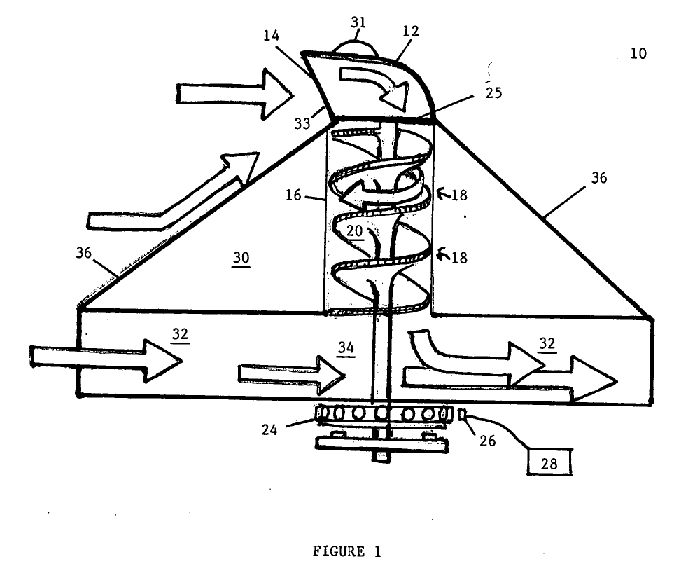

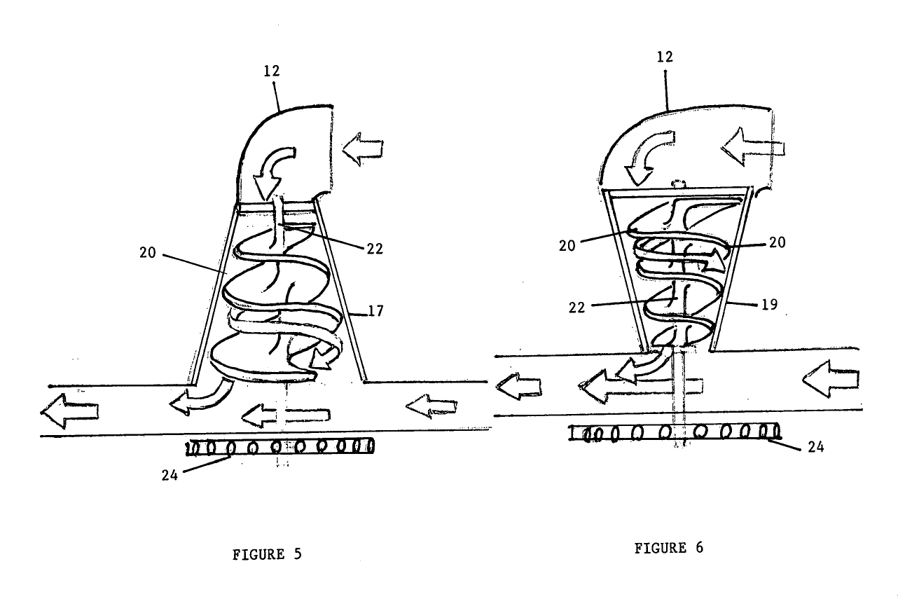

FIG. 1 is illustrative of the basic structure of the vertical wind turbine 10 of the present invention. Vertical wind turbine 10 has an upper intake manifold 12 having a generally horizontal intake port 14. Intake manifold 12 could be characterized as L-shaped in configuration in that it transforms a horizontal wind vector into a vertical wind vector directing the wind vector downwardly into a vertical downspout or air shaft 16, which is preferably cylindrical in cross-section, but may be formed in a truncated conical section 17 or an inverted truncated conical section 19 (FIGS. 5 and 6).

Mounted within vertical downspout 16 are a plurality of wind turbines 18, the blades 20 of which are mounted to a centrally disposed vertical shaft 22, the lower end 21 of which is mounted on a magnetically supported disk 24 thereby allowing the centrally mounted rotatable shaft 22 and wind turbine blades 20 mounted thereon to float and to rotate with a minimum of friction. The upper end of shaft 22 is braced 25 to the inner wall of the upper end of vertical air shaft 16. Positioned about the magnetically floating disk 24 are a plurality of conductive brushes 26 which in turn are in communication with a generator 28.

The horizontal vectored wind entering the intake manifold 12 is redirected downwardly into vertical downspout or air shaft 16 causing the blades 20 of the wind turbine 10 and centrally rotatably disposed shaft 22 to rotate, thereby rotating the magnetically floating disk 24 causing contact with the plurality of brushes 26 disposed thereabout, which in turn are in communication with the generator 28 for the generation of an electrical current.

The performance of the vertical wind tunnel 10 can be enhanced by the addition of certain structural elements. An extended body member 30 may be disposed about the vertical downspout or air shaft 16 so as to define a passageway 32 below the vertical downspout 16 and to cause a venturi affect at location 34 below the downspout or air shaft 16 causing a low pressure venture effect or partial vacuum at this location which will further enhance the performance of the vertical wind turbine 10 and its associated rotating blades 20 and shaft by causing the wind vectored into the intake manifold 12 and downwardly in the vertical downspout or air shaft 16 to increase speed as it traverses the vertical downspout 16 thereby imparting greater rotation to the turbine blades 20.

Still further, the extended body member may be formed with a wing or fin 36 so as to react to the wind vector and cause the inlet port 14 of the intake manifold 12 to face in direction of the primary wind vector regardless of the direction from which it emanates. In this type of configuration, the intake manifold 12, vertical downspout or air shaft 16 and the extended body member 30 would all be secured and rotate as a unitary structure. Alternatively, the intake manifold 12 may be rotatable independent of the vertical downspout 16 and extended body member 30, and may have associated therewith, its own independent fin or wing 31 to cause the intake manifold 12 to rotate in response to the primary wind vector, thereby causing the inlet port 14 of the intake manifold 12 to always face into the primary wind vector while the vertical downspout 16 and extended body member 30 would remain stationary with the extended body member still performing its task of defining a passageway 32 beneath the vertical downspout 16 in order to create the aforesaid venturi affect and low pressure, partial vacuum area 34.

The embodiment illustrated in FIG. 1 could be used in conjunction with similar spaced apart vertical wind tunnels to form a wind tunnel farm similar to those identified in the prior art, but with the elimination of the pedestals and the vertical plane oriented blades of such wind farms. Still further, by incorporated a mesh 33 covering of the inlet port 14 of the intake manifold 12, Applicant's vertical wind tunnel 10 eliminates any danger to migrating birds. Still further, while the extended body member 30 of the independent vertical wind turbine of FIG. 1 enhances the performance of the vertical wind turbine by creating a venturi affect and thus a low pressure, partial vacuum area which will further accelerate the primary wind vector directed downwardly through the downspout or shaft 16, the vertical wind turbine 10 will still perform and generate electricity without such extended body member 30 as long as there is a passageway beneath the vertical downspout 16 for the egress of air from the vertical downspout.

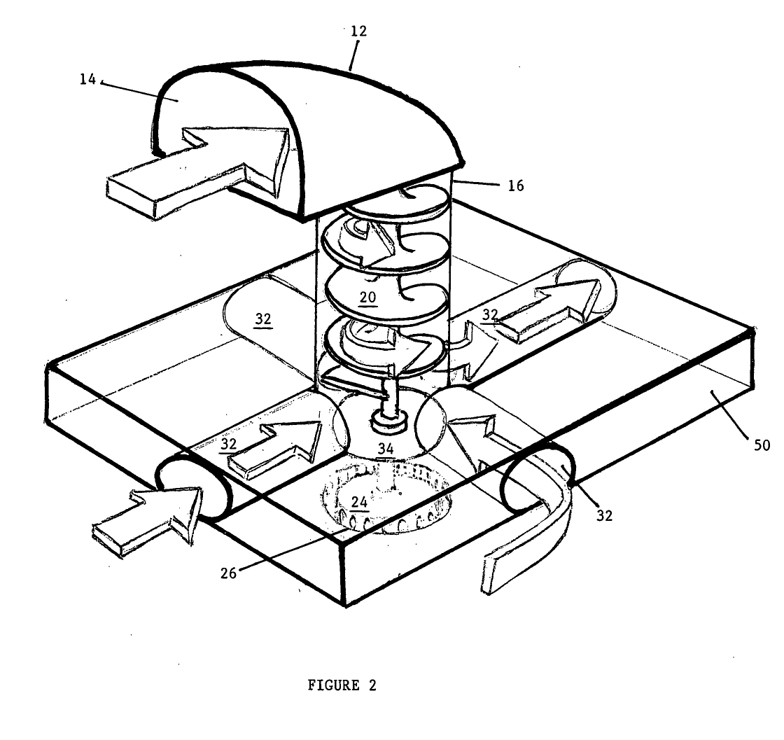

FIG. 2 is illustrative of the manner in which the vertical wind turbine 10 of FIG. 1 could be applied to a stationary structure. In this configuration, the structure 50 would have a vertical downspout or air shaft 16 and associated centrally rotative disposed shaft 24 and turbine blades 20 mounted in or on the structure 50, such as the roof. The intake manifold 12 in this embodiment would be rotatable independently of the vertical downspout 16 to allow the horizontal intake port to face the direct vector of the wind depending upon the direction from which it was blowing. Since the structure is stationary, and the vertical downspout 16 is stationary, the passageways 32 beneath the vertical downspout 16 in order to create the venturi, low pressure, partial vacuum affect must be fixed within the structure and therefore would not operate as optimally as the structure illustrated in FIG. 1 since the passageways 32 would not always be facing the primary vector of the wind, but nevertheless, airflow to the bottom portion of the vertical downspout 16 and its concomitant venturi affect can be partially achieved. The centrally disposed rotatable shaft 22 and wind turbine blades 20 would be mounted on the magnetically floating disk 24 in the same manner as illustrated in FIG. 1 with a plurality of brushes 26 in electrical communication with a generator 28 for the generation of an electric current.

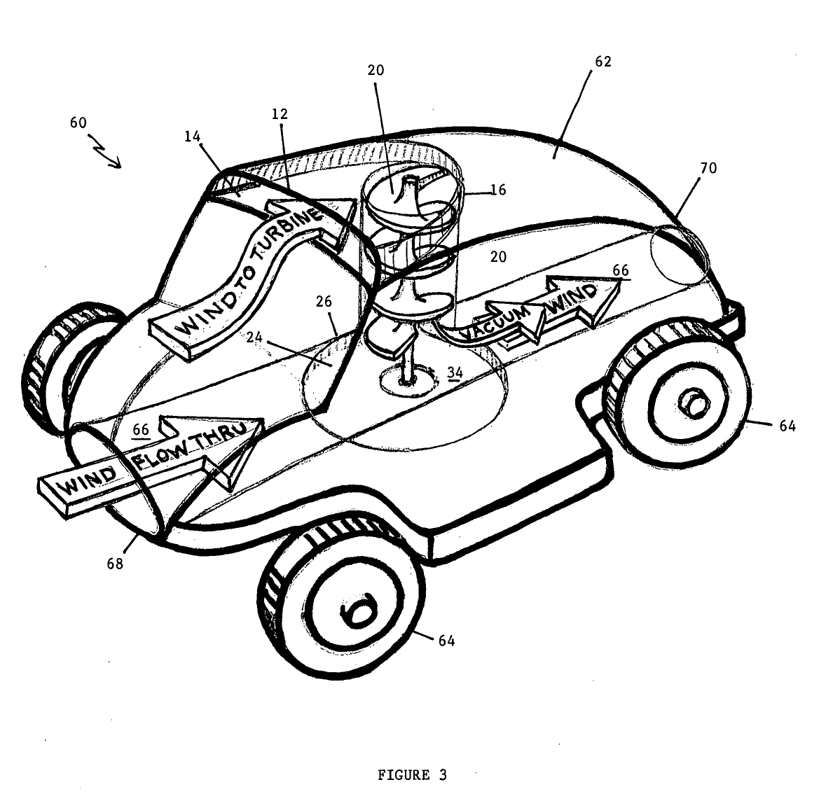

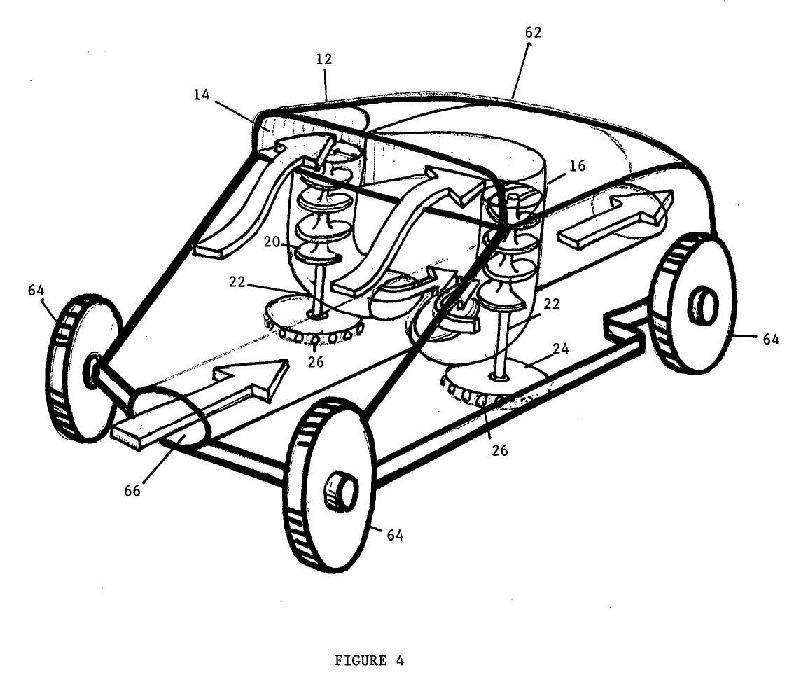

FIGS. 3 and 4 are illustrative of the adaption of the vertical wind turbine 10 of the present invention to a vehicle. FIG. 3 is illustrative of a single vertical wind turbine and FIG. 4 illustrates the possibility of incorporating two vertical wind turbines in or on the same vehicle. In the illustration of FIG. 3, an electric or hybrid vehicle 60 is disclosed having a body 62, supported on a plurality of wheels 64, the wheels being powered by electric motors which in turn are in communication with a bank of batteries (not shown) for powering the vehicle. Under normal operation, with the batteries fully charged, the operator would have knowledge of the maximum distance that the vehicle could travel on that battery charge without recharging the batteries. Such limitations greatly limit the use of an electric or hybrid vehicle and also limit the public's enthusiasm for such vehicles. However, with the incorporation of Applicant's vertical wind turbine, it is possible to use the forward force of the vehicle while traveling to generate electric current to recharge the batteries thereby extending the distance which the vehicle may travel.

A vertical wind turbine of the type described with respect to FIGS. 1 and 2 would be positioned within or on the vehicle with the intake manifold 12 and horizontal intake port 14 extending upwardly above the body of the vehicle. In this configuration, the horizontal intake port 14 and intake manifold 12 may be rotatable independently of the vertical downspout of the vertical wind turbine, but since the vehicle will be charging primarily when moving, the intake manifold 12 and horizontal intake port 14 may be fixedly secured to the vertical downspout 16 so as to direct the horizontal intake port 14 towards the forward end of the vehicle.

In the embodiment illustrated in FIG. 3, a horizontal air shaft 66 would extend from the front 68 of the vehicle 60 to the rear 70 of the vehicle allowing air or wind to pass through the shaft and through the venturi area 34 caused by a narrowing of the shaft 66 below the vertical downspout 16. A low pressure area or partial vacuum in the venturi area is thus created thereby increasing the speed of the wind directed downwardly through the vertical downspout 16 and past the plurality of wind turbine blades 20 so as to enhance the performance of the vertical wind turbine 10. The wind turbine mounting on a magnetically floating disk 24 with associated brushes 26 and electrical connections would be the same as that illustrated in FIGS. 1 and 2 with the current generated being utilized to recharge the vehicles battery bank while the vehicle is moving.

FIG. 4 is a perspective partial cross-sectional view of a second embodiment of the vertical wind tunnel of the present invention incorporated in or on a vehicle. The mounting method and operation would be identical to that as illustrated in FIG. 3. The difference in FIG. 4 is that for further efficiency, two vertical wind turbines 10 would be mounted in or on the vehicle, but would share a common central passageway 66 in order to establish the venturi affect.

The vertical wind turbine of the present invention has been described thus far with respect to a cylindrical vertical downspout or airshaft 16. However, the shape of the vertical downspout or air shaft may vary without departing from the spirit and scope of the invention. FIGS. 5 and 6 illustrate alternative embodiments of the vertical air shaft 16. FIG. 5 illustrates a truncated conical section 17 which diverges from top to bottom and in which the blades 20 increase in diameter to match the diverging conical section. FIG. 6 illustrates an inverted truncated conical section which converges from top to bottom and in which the blades 20 decrease in diameter. The centrally disposed vertical mounting shaft and magnetically floating disk 24, as well as the other elements of the vertical wind turbine would remain the same.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A vertical wind turbine for converting wind energy to electricity, the vertical wind turbine comprising:
a vertical tubular housing member having an open lower exhaust end, and an inverted L-shaped upper intake end, said inverted L-shaped upper intake end having a wind facing opening for the ingress of wind, said inverted L-shaped upper intake end redirecting said wind vertically downwardly into said vertical tubular housing;
a magnetically supported disk mounted proximate said lower end of said vertical tubular housing, said magnetically supported disk having a plurality of conductive contact points mounted about a circular periphery thereof, said conductive contact points in rotatable selective communication with a plurality of brushes fixedly positioned about said magnetically supported disk, said brushes in communication with a generator;
a centrally disposed vertical shaft mounted on said magnetically supported disk and extending upwardly in said vertical tubular housing having its upper end rotatably secured by a plurality of braces to an inner surface of said vertical tubular housing, said centrally disposed vertical shaft having a plurality of horizontally oriented turbine blades secured thereto in series, said centrally disposed vertical shaft and said horizontally oriented turbine blades rotatable under the influence of wind energy entering said inverted L-shaped upper intake end and being directed downwardly, said rotating centrally disposed vertical shaft and said rotating turbine blades causing said magnetically supported disk to rotate in relationship to said fixed brushes in communication with said generator to convert wind energy to electricity.

2. The vertical wind turbine in accordance with claim 1 wherein said inverted L-shaped upper intake end housing member is rotatable on said vertical tubular housing, said inverted L-shaped upper intake end having a wing foil oriented responsive to wind direction, thereby maintaining said inverted L-shaped upper intake end in a wind facing orientation.

3. The vertical wind turbine in accordance with claim 1 wherein said lower portion of said vertical tubular housing intersects with a horizontal tubular passageway of venturi design creating a lower barametric pressure in said lower end of said vertical wind turbine thereby enhancing the flow of air through said vertical wind turbine.

4. The vertical wind turbine in accordance with claim 3 wherein said vertical wind turbine would be mounted on the roof of a fixed structure.

5. The vertical wind turbine in accordance with claim 3 wherein said housing of said vertical wind turbine would be fixed and mounted within a vehicle, said intake manifold facing forwardly towards said front of said vehicle, the forward motion of said vehicle causing air flow into said inverted L-shaped upper intake end.

6. The vertical wind turbine in accordance with claim 1 wherein said vertical tubular housing member is cylindrical in cross-section.

7. The vertical wind turbine in accordance with claim 1 wherein said vertical tubular housing member is a partial conical section.

8. The vertical wind turbine in accordance with claim 1 wherein the vertical tubular housing member is an inverted partial conical member.

9. The vertical wind turbine in accordance with claim 7 wherein said horizontally oriented turbine blades decrease in diameter from said lower end of said partial conical-shape member to said upper end.

10. The vertical wind turbine in accordance with claim 8 wherein said horizontally oriented turbine blades increase in diameter from said lower end of said vertical tubular housing to said upper end.
